(19) United States
(12) Patent Application Publication
(10) Pub. No.: US 2006/0083765 A1
(43) Pub. Date: Apr. 20, 2006

(54) Methods for using and manufacturing a pesticide

(76) Inventor: David L. Schlauch, League City, TX (US)

Correspondence Address: LAW OFFICES OF TIMOTHY M. BARLOW, P.O. BOX 64775, TUCSON, AZ, 85728-4775, US

(21) Appl. No.: 10/968,484

(22) Filed: Oct. 19, 2004

(51) Int. Cl. A01N 25/08; A01N 65/00

(52) U.S. Cl. 424/410; 424/725.1

(57) ABSTRACT

A pesticide made from an amorphous silicate material with strong hydrophilic properties. A method of controlling biological pests using a burned rice hull material comprises the steps of: distributing the burned rice hull material on or mixed into a pest environment. The material may be used in its pure form or mixed with other materials for application on pests environments. The material may be used above or below ground and is completely safe to handle, both in manufacturing and in application, and is very effective against animals with exoskeletons and with very high water content in their bodies.

### BACKGROUND OF THE INVENTION

1. Field of the Invention

The present invention pertains to pesticides. More specifically, the present invention pertains to a pesticide made from burned rice hulls.

2. Description of the Prior Art

Pesticides have been used for many years. Modern chemistry has brought us a wide variety of pesticides, with a different formulation for virtually every crop, soil or pest condition or situation. Most of these chemicals are organic in nature and skin contact with them can be very hazardous. Further, many of these compounds create a dust or vapor that is harmful to eyes and lungs. The dust or vapors may also be quite flammable. When handling these chemicals, it is advisable to wear gloves, eye protection and a mask or respirator.

Manufacturing methods for organic chemical pesticides are highly involved, requiring a tremendous quantity of specialized equipment to create each of the chemicals required for synthesis of the final pesticide compound. However, one thing that modern chemistry has been lacking is a pesticide that is easy to produce and easy to use, that is safe to handle and store, that kills a wide variety of common pests, and that is nontoxic to plants, humans and animals.

The object of traditional organic pesticides is to disturb the chemical balance in a living organism. The introduction of new chemicals into the pests' environment causes subsequent biochemical imbalances, leading to death. However, the most basic chemical found in animals is water. Disturbance of the balance of water in a living organism, without toxic chemicals, would result in pest control without the environmental impact of complex organic chemicals. A material that both robs a pest's environment and body of water during dry periods and contributes excessive amounts of moisture during wet periods would be devastating to pest populations. Diatomaceous earth and silica gel have been tried in this role, but are not acceptable. Each of these materials acts to hold onto water too strongly. A medium for disrupting the balance of water in a living organism or in its habitat needs to have two properties: first it needs to remove water from balanced environments in times of little moisture, and second, it needs to add extra water to balanced environments in times of water abundance.

Thus, what is needed is a pure, cheap, easy to produce, easy to use and effective pesticide that is nontoxic to plants, mammals and other animals, yet kills common pests quickly.

### SUMMARY OF THE PRESENT INVENTION

In the present invention, a new and improved pesticide is provided. The pesticide is made from burned rice hulls. The method of using the rice hulls as a pesticide includes the steps of: distributing the burned rice hull material on or into a pest environment. This process is effective both above and below ground level. The burned rice hull material may be mixed with soil, pest bait, traditional pesticides, diatomaceous earth and other materials to achieve the desired results.

A side benefit is that the burned rice hull material retains moisture for subsequent release and use by the plant materials during periods of dry weather. In its pure, unmixed form, the burned rice hull material may be used near food supplies and storage areas with complete safety.

The burned rice hull material of the present invention has many objects, advantages and uses which will be more apparent from reading the description which follows.

### DETAILED DESCRIPTION OF THE PRESENT INVENTION

The pesticide material is made from burned rice hulls. This pesticide works well both above and below ground level and in wet areas. The method of using the rice hulls as a pesticide includes the steps of: distributing the burned rice hull material on a pest environment. Several other variations of this method are useful and effective as well, depending on the particular pest. The burned rice hull material has a strong affinity for water, but it will release the water for the sake of equilibrium. During dry periods, the material will supply water to its surroundings until it achieves equilibrium. That is, the material will supply water to the environment when the environment overcomes the material's hold on the water. In the same way, the material will absorb a large amount of water from a wet environment, until the material is saturated. The wet and dry cycles of the material lag behind that of normal soil or pest environments, causing a perpetual imbalance. The aforementioned embodiment is particularly effective against common ants, fire ants, soil grub worms, slugs, snails, scorpions, spiders, and other pests. The highly hydrophilic nature of the burned rice hull material also acts to create a water imbalance that draws the water from the bodies of slugs, snails and related pests, and kills them. Other animals are affected through the destruction of the water balance in their environment and respiratory systems as well. This material is also effective in reducing mosquitoes, due to the destruction of their breeding habitat. To destroy mosquito breeding areas, the burned rice hull material is placed below damp, wet, low-lying areas to absorb excess water. Without surface water, the mosquitoes cannot breed and the larvae cannot survive.

In another embodiment, the burned rice hull material may be mixed with soil, pest bait, insecticide, diatomaceous earth and other materials. The burned rice hull material prevents the bait from drying too quickly. The material also provides moisture control where the bait cannot tolerate excess water. The mixture is then introduced into the pest environment. A burned rice hull material mixed with bait is very effective against common ants and fire ants, for example. The small pieces and sharp edges of the material act to become lodged in the joints of the exoskeletons. This promotes dehydration of the pests. In addition, when the material is mixed with diatomaceous earth, it is very effective against roaches. However, diatomaceous earth will not work as effectively by itself. Diatomaceous earth is too hydrophilic and will not release water easily, but it does act to irritate or damage the exoskeleton of the roaches.

In another embodiment, the burned rice hull material is injected or inserted into an underground pest environment. The burned rice hull material is then mixed with the underground soil to distribute the burned rice hull material. This method is very effective against fire ants and mole crickets. Fire ants are a particular nuisance in many areas. Numerous chemicals are available to combat them. However, these chemicals often need multiple applications and are hazardous to handle. The burned rice hull material is quite unique in its safety and effectiveness. Upon injection into the fire ant nest, most, if not all, of the ants will be killed within a few days, due to destruction of their delicately balanced environment. Ants need very closely regulated atmospheric conditions to survive. Ants will closely regulate the humidity level in the nest to promote the growth of their cultivated crops and the proper development of their pupae and larvae. If the conditions inside the nest are not within an acceptable range, then the ants cannot raise their crops and the pupae and larvae cannot survive. The burned rice hull material destroys the balance of water in the nest. During wet periods, the material absorbs and holds onto the water, releasing it slowly and disturbing the moisture level in the nest. During dry periods, the material acts to take water away from the carefully regulated environment inside the nest. The ants cannot eliminate the burned rice hull material, thus the nest becomes uninhabitable. However, since there is not a biological invasion to repel, the ants do not act to evacuate the nest. They die in the nest, working fruitlessly to correct the water imbalance. The mass death of an entire colony taints the nest, rendering it virtually unusable for any future ants that might happen to find the old nest. In the case of fire ants, it is typical for the colony to attempt to relocate the nest to one of several satellite nests likely to exist. A subsequent injection of the burned rice hull material into the newly active satellite nests will eliminate the pests before they have a chance to establish a new satellite. Due to the permanently contaminated nature of the nests, the fire ants will not return. The material is estimated to have an effective life span of over 100 years.

The material may be used safely in marshy areas, children's play areas, and around the home. It has been discovered that the material is effective against a wide variety of pests having exoskeletons, such as insects and arachnids. The material is also effective against pests with a high water content, such as slugs and snails. Among pests with exoskeletons, the tiny pieces of the material become stuck in the joints between the head, thorax and abdomen. The material is extremely irritating and debilitating for the pests. The hydrophilic nature of the material removes vitally-needed water from the pests' bodies, killing them. As a boon to gardeners and farmers, the material has been found to be completely harmless to earthworms, further emphasizing the material's safety around the food supply. This is because the material does not kill through ingestion.

In the preferred embodiment, the burned rice hull material is an amorphous structure comprising silica and other oxides, with a small amount of carbon and traces of other compounds. The material has a very large surface area created by its irregular shape and numerous tiny voids. This material may be made through a number of processes. In one embodiment the material is made via the process disclosed in U.S. Pat. No. 5,503,931, A Moisture Absorbing Material And Methods Of Production. The disclosed method includes the steps of: parboiling the rice under pressure and at a temperature to dissolve cellulose from the hulls and increase the moisture content thereof to at least 30%, drying the rice hulls to reduce the moisture content to 10 to 18% by volume to cause internal fracturing, breaking the rice hulls into pieces, separating the broken rice hulls from the grain and bran, and burning the broken rice hulls at high temperatures to produce a skeletal residue of amorphous silicate material wherein said particulate amorphous silicate is cellular and non-biodegradable. Further research and experimentation has revealed that the parboiling step may be omitted, depending on the type of rice hull used. The hulls of several common varieties of rice are commonly available for conversion into a pesticide. Each has different moisture properties, depending on whether it is long grain or short, the particular variety of rice, and whether it is wet or dry field rice. The hulls of some varieties of rice have a sufficient moisture content. These varieties do not need to be parboiled to increase their moisture content.

No matter which process is used, if the process is appropriate for the type of rice, the resulting burned rice hull material comprises a lightweight, sterile, moisture absorbing amorphous particulate silicate material comprising from 91% to 95% by weight silicon dioxide with 2 to 5 ppm nitrates and 400 to 1000 ppm nitrogen in non-soluble form, a carbon content of from 5% to 9% by weight, and having a bulk density in the range of from 23 to 28 pounds per cubic foot. The moisture content is reduced to 10 to 18% by volume to cause internal fracturing, and then broken into pieces and burned at high temperatures to produce a cellular, amorphous silicate that is non-biodegradable. Any amorphous silicate material with a strong attraction to water would be effective in performing this role.

It is preferred that the material be produced via burning between 700° F. and 2250° F. Carbonization of the material occurs below 700° F. and carcinogens are created above 2250° F. The amorphous silicate produced by such high temperature burning is sterile and non-biodegradable. In its pure, unmixed form, the burned rice hull material may be used near food supplies and storage areas with complete safety.

It is to be understood that the present invention is not limited to the embodiments described above, but encompasses any and all embodiments within the scope of the following claims.

I claim:

1. A method of controlling biological pests using a burned rice hull material, comprising the steps of:
(a) mixing the burned rice hull material with a second material; and
(b) introducing the mixture into a pest environment.

2. The method of controlling biological pests using the burned rice hull material of claim 1, where the second material is diatomaceous earth.

3. The method of controlling biological pests using the burned rice hull material of claim 1, where the second material is a pest bait.

4. The method of controlling biological pests using the burned rice hull material of claim 1, where the second material is a pesticide.

5. A method of controlling biological pests using a burned rice hull material, comprising the steps of:
(a) injecting the burned rice hull material into a pest environment.

6. The method of controlling biological pests using a burned rice hull material of claim 5, where the pest environment is underground.

7. The method of controlling biological pests using a burned rice hull material of claim 6, comprising the steps of:
(b) mixing the burned rice hull material with the underground soil.

8. A method of controlling biological pests using a burned rice hull material, comprising the steps of:
(a) distributing the burned rice hull material on a pest environment.

9. The method of controlling biological pests using a burned rice hull material of claim 8, where the burned rice hull material comprises a lightweight, sterile, moisture absorbing amorphous particulate silicate material comprising from 91% to 95% by weight silicon dioxide with 2 to 5 ppm nitrates and 400 to 1000 ppm nitrogen in non-soluble form, a carbon content of from 5% to 9% by weight, and having a bulk density in the range of from 23 to 28 pounds per cubic foot obtained by then drying the material to reduce the moisture content to 10 to 18% by volume to cause internal fracturing, and then breaking the material into pieces wherein said particulate amorphous silicate is cellular and non-biodegradable.

10. The method of controlling biological pests using a burned rice hull material of claim 9, further comprising the step of parboiling the rice under pressure and at a temperature to dissolve cellulose from the hulls and increase the moisture content thereof to at least 30%.

11. A stable pesticide composition comprising:
a lightweight, sterile, moisture absorbing amorphous particulate silicate material comprising from 91% to 95% by weight silicon dioxide with 2 to 5 ppm nitrates and 400 to 1000 ppm nitrogen in non-soluble form, a carbon content of from 5% to 9% by weight, and having a bulk density in the range of from 23 to 28 pounds per cubic foot obtained from drying rice hulls to achieve a reduced moisture content of 10% to 18% by volume to cause internal fracturing, and then breaking the rice hulls into pieces wherein said particulate amorphous silicate is cellular and non-biodegradable.

12. The stable, nontoxic pesticide of claim 11, where the rice is parboiled under pressure and at a temperature to dissolve cellulose from the hulls and increase the moisture content thereof to at least 30% prior to drying the rice hulls.

13. The stable, nontoxic pesticide of claim 11, where the pesticide is effective against animals with exoskeletons.

14. The stable, nontoxic pesticide of claim 11, where the pesticide is effective against slugs, snails and animals with very high water content.
